(19) United States
(12) Patent Application Publication
(10) Pub. No.: US 2009/0316144 A1
(43) Pub. Date: Dec. 24, 2009

(54) DEVICE FOR DETECTING THE CONDITION OF AN OPTICAL FILTER AND ILLUMINATION DEVICE

(75) Inventor: Shotaro KOBAYASHI, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/143,042

(22) Filed: Jun. 20, 2008

(51) Int. Cl. G01N 21/88

(52) U.S. Cl. 356/239.2

(57) ABSTRACT

A device for detecting the condition of an optical filter which is arranged in the optical path of a light source so as to cut light of a specific wavelength from the light emitted by the light source. A detection light source outputs a detection light beam which passes through the optical filter so that the detection light beam crosses the optical path. A photoreceptor element receives the detection light beam which has passed through the optical filter. A detection processor detects the condition of the optical filter in accordance with the intensity of the detection light beam received by the photoreceptor element.

### BACKGROUND OF THE INVENTION

1. Field of the Invention

The present invention relates to a device for detecting the condition of an optical filter such as an infrared cut filter, and an illumination device provided with the detecting device, together which are applicable to an endoscope system, for example.

2. Description of the Related Art

In an endoscope, an illumination light beam, output by a light source such as a xenon lamp or a halogen lamp, is emitted towards the inside of a body undergoing examination, to illuminate the subject. Since the illumination light beam output from the light source contains infrared radiation, the endoscope and the inside of the body would be subjected to thermal damage if the unmodulated illumination light beam were to enter the light guide of the endoscope. Therefore, the illumination light beam usually enters the light guide after the infrared radiation is blocked by an infrared cut filter.

In the infrared cut filter, the area through which the illumination light beam passes gets hot, so that a temperature difference arises between the area where the illumination light beam passes and the area where it does not. The irradiated area is thus prone to thermal expansion, which may result in strain and cracking of the filter. In recent years, with the improved performance and more frequent use of high-intensity lamps, the likelihood of cracking of the infrared cut filter has increased.

Conventionally, as described in Japanese unexamined patent publication No. (HEI) 2-250005, for example, it is known that an infrared cut filter is split into multiple parts, so that the amount of distortion generated in the filter is reduced, and thus decrease the possibility of cracking. However, this conventional method degrades the performance of the filter due to the splits.

### SUMMARY OP THE INVENTION

Therefore, an object of the present invention is to provide a device for detecting the condition of an optical filter, and an illumination device, by which a change of condition such as crack or cleft of the optical filter, can be detected.

According to the present invention, there is provided a device for detecting the condition of an optical filter, which is arranged in the optical path of a light source, so as to cut light of a specific wavelength from the light emitted by the light source, the device comprising a detection light source, a photoreceptor element, and a detection processor.

The detection light source outputs a detection light beam which passes through the optical filter so that the detection light beam crosses the optical path. The photoreceptor element receives the detection light beam which has passed through the optical filter. The detection processor detects the condition of the optical filter in accordance with the intensity of the detection light beam received by the photoreceptor element.

According to the present invention, there is provided an illumination device comprising a first light source, an optical filter, a detection light source, a photoreceptor element, and a detection processor.

The first light source emits an illumination light beam towards a subject along a predetermined optical path. The optical filter is arranged in the optical path to remove light of a specific wavelength from the illumination light beam. The detection light source outputs a detection light beam, which passes through the optical filter so that the detection light beam crosses the optical path. The photoreceptor element receives the detection light beam which has passed through the optical filter. The detection processor detects the condition of the optical filter according to the intensity of the detection light beam received by the photoreceptor element.

### BRIEF DESCRIPTION OF THE DRAWINGS

The objects and advantages of the present invention will be better understood from the following description, with reference to the accompanying drawings in which:

FIG. 1 is a block diagram showing the general structure of the endoscope system to which a first embodiment of the present invention is applied;

FIG. 2 is a partially sectional side view of a lamp housing;

FIG. 3 is a front view of the lamp housing;

FIG. 4 is a front view of an infrared cut filter;

FIG. 5 is a graph showing the voltage generated in a photodiode;

FIG. 6 is a flowchart showing the condition detection routine;

FIG. 7 is a front view of the lamp housing of a second embodiment;

FIG. 8 is a block diagram showing a part of the endoscope system to which a third embodiment of the present invention is applied; and

FIG. 9 is a timing chart showing the timings of drive pulses and detection pulses of a laser diode in the third embodiment.

### DESCRIPTION OF THE PREFERRED EMBODIMENTS

The present invention will be described below with reference to the embodiments shown in the drawings.

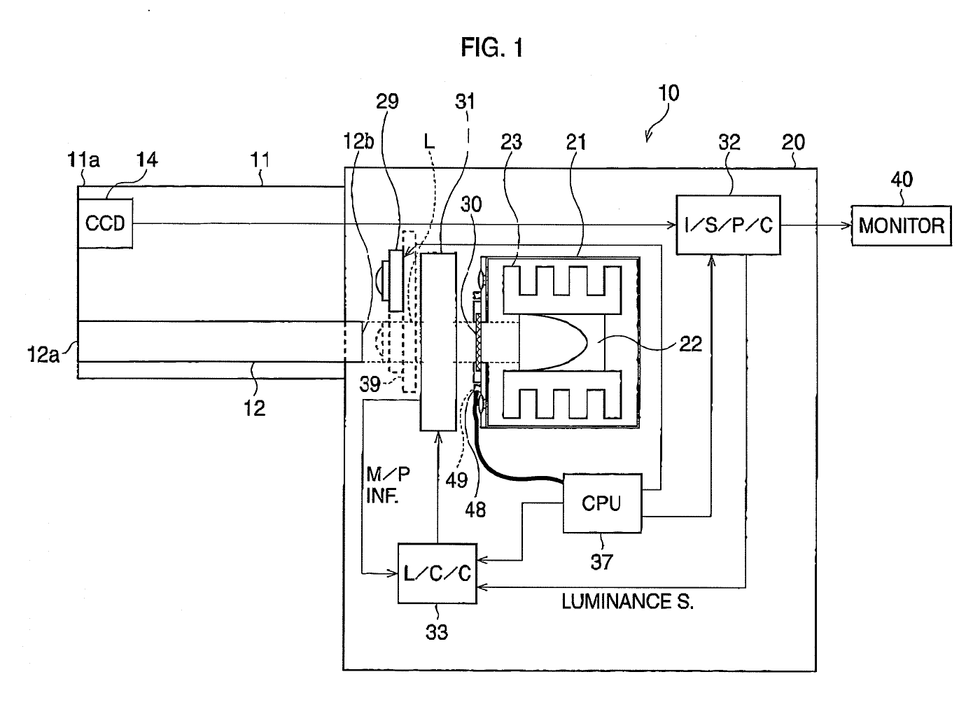

FIG. 1 is a block diagram showing the general structure of an endoscope system 10, to which a first embodiment of the present invention is applied. The endoscope system 10 has a video processor 20, a video-scope 11, which is attached to the video processor 20 and is inserted into the human body to obtain a subject image, and a monitor 40 connected to the video processor 20.

The video-scope 11 is provided with a light guide 12 inserted therein. An emitting end 12a of the light guide 12 is positioned at the tip portion 11a of the video-scope 11, and an incident end 12b of the light guide 12 is disposed in the video processor 20. The video-scope 11 has an imaging device 14 such as a CCD, at the tip portion 11a. The video processor 20 processes an image signal obtained through the video-scope 11, and has a lamp housing 21, so that the video processor 20 functions as an illumination device for the endoscope system 10. The video processor 20 has a CPU 37, by which the video processor 20 is controlled as a whole.

The lamp housing 21 has a lamp 22 (i.e., a first light source) that emits an illumination light beam, and a heat sink 23, which surrounds the lamp 22 to cool the lamp 22. The lamp 22 is a xenon lamp, a halogen lamp, or the like, which outputs an illumination light beam containing infrared radiation. The illumination light beam output from the lamp 22 passes through the optical path L, and strikes the incident end 12b of the light guide 12.

An infrared cut filter 30 and a light-amount control aperture 31 are arranged in the optical path L, and are disposed between the incident end 12b and the lamp 22, the infrared cut filter 30 being positioned closer to the lamp 22. The infrared cut filter 30 is formed in a plate shape, and is an optical filter which reflects or absorbs light in the infrared region and at least some of the light of nearby wavelengths. The quantity of the illumination light beam is adjustable by the light-amount control aperture 31 prior to entering the incident end 12b.

The illumination light beam, entering the incident end 12b of the light guide 12, passes through the light guide 12 and is transmitted to the emitting end 12a, so as to illuminate the subject (e.g., living body tissue) through the emitting end 12a or the tip portion 11a of the video-scope 11. The illumination light beam is reflected off the subject, and the reflecting light beam is received by the imaging device 14 through an objective lens (not shown), so that a subject image is formed on the imaging device 14 due to the received reflecting light beam, thus generating an image signal corresponding to the subject image in the imaging device 14. The image signal is transmitted to an image signal processing circuit 32 provided in the video processor 20, in which a video signal having a luminance signal and color difference signals is generated based on the image signal. The video signal is subjected to a predetermined image process in the image signal processing circuit 32, and then output to the monitor 40, in which the subject image is displayed. Note that the luminance signal is input to a light-amount control circuit 33 from the image signal processing circuit 32.

The light-amount control aperture 31 is controlled by a motor (not shown) which is driven by the light-amount control circuit 33, so that the rotational position of the motor shaft can be controlled to adjust the opening degree of the aperture 31. That is, the light-amount control circuit 33 drives the motor based on motor position information, in accordance with information about the opening degree of the aperture 31, and a luminance signal input to the light-amount control circuit 33, and thus, the opening degree of the aperture 31 is adjusted, so that the amount of illumination light emitted, from the tip portion 11a is maintained at a proper value.

The video processor 20 is provided with an alternate light source 29, containing an LED, for example, to output an alternate light beam which contains virtually no infrared light. The alternate light source 29 is driven based on a control signal output by the CPU 37, so that the alternate light source 29 slides upward and downward (as in FIG. 1) on a slide mechanism 39, and can be positioned closer to the incident end 12b than the light-amount control aperture 31 in the optical path L. The alternate light beam emitted from the alternate light source 29 positioned in the optical path L, is directed at a subject similarly to the illumination light beam of the lamp 22.

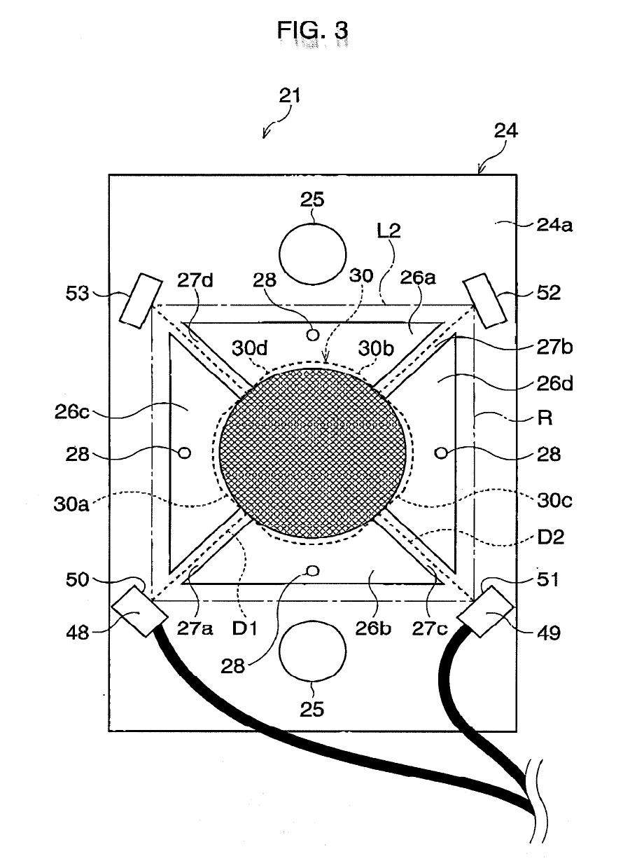

A laser diode (i.e., detection light source) 48 and a photodiode (photoreceptor element) 49 are provided to a front surface of the lamp housing 21 (see FIG. 3). The laser diode 48 emits a laser beam (detection light beam), for detecting the condition of the infrared cut filter, from an emitting end 50 of the laser diode 48, and the laser beam is received by a light-receiving surface 51 of the photodiode 49 (see FIG. 3). The laser diode 48 and the photodiode 49 are connected to the CPU 37, so that the laser diode 48 is controlled and the condition of the infrared cut filter 30 is detected on the basis of the intensity of the laser beam.

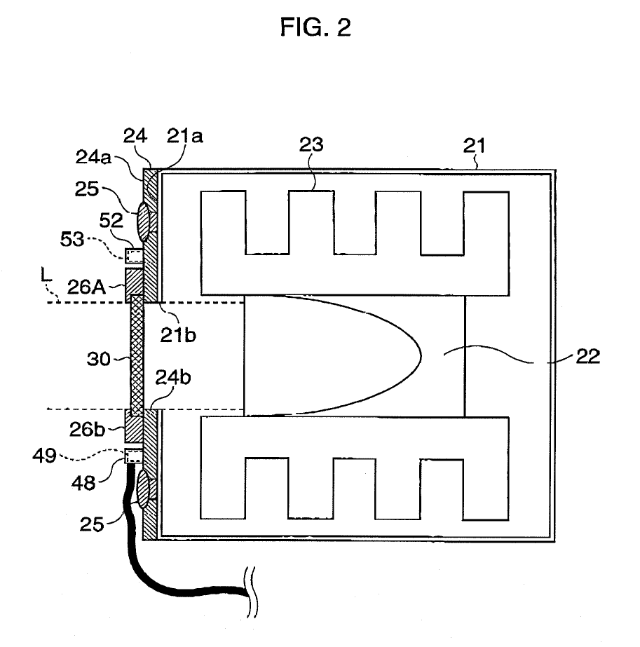

As shown in FIG. 2, the lamp housing 21 is a box-shaped housing, in which an opening 21b is formed in a front wall 21a and a metal plate 24 is fixed to the front wall 21a by a fastener 25. An opening 24b is formed in the metal plate 24 so as to coincide with the opening 21b. The infrared cut filter 30 is fixed to the metal plate 24 to cover the openings 21b and 24b. The optical path L of the lamp 22 passes through the openings 21b and 24b, and the infrared cut filter 30.

As shown in FIG. 3, the emitting end 50, the light-receiving surface 51, a first reflecting mirror 52, and a second reflecting mirror 53 are arranged on a front surface 24a of the metal plate 24, so as to enclose the infrared cut filter 30. The emitting end 50 and the first reflecting mirror 52 are disposed on the same plane as the filter 30, and are positioned at the lower-left corner and the upper-right corner of an imaginary rectangle R (a square in this embodiment) enclosing the filter 30. The second reflecting mirror 53 and the light-receiving surface 51 are positioned at the upper-left corner and the lower-right corner of the imaginary rectangle R. Thus, the emitting end 50 and the first reflecting mirror 52 are on the diagonal D1 of the rectangle R, and the light-receiving surface 51 and the second reflecting mirror 53 are on the diagonal D2 of the rectangle R, in such a manner that the first reflecting mirror 52 faces the emitting end 50 and the second reflecting mirror 53, and the second reflecting mirror 53 faces the first reflecting mirror 52 and the light-receiving surface 51.

Four holding members 26a, 26b, 26c, and 26d are provided inside the rectangle R so as to enclose the infrared cut filter 30. Each of the holding members 26a-26d is a metal plate, the inner periphery of which abuts the outer periphery of the infrared cut filter 30. The holding members 26a-26d are positioned on the upper, lower, left, and right sides of the infrared cut filter 30 so as not to obstruct the two diagonals D1 and D2, so that gaps 27a, 27b, 27c, and 27d are formed among the holding members 26a-26d. The holding members 26a-26d are attached to the metal plate 24 by pins 28, so that the infrared cut filter 30 is fixed to the metal plate 24.

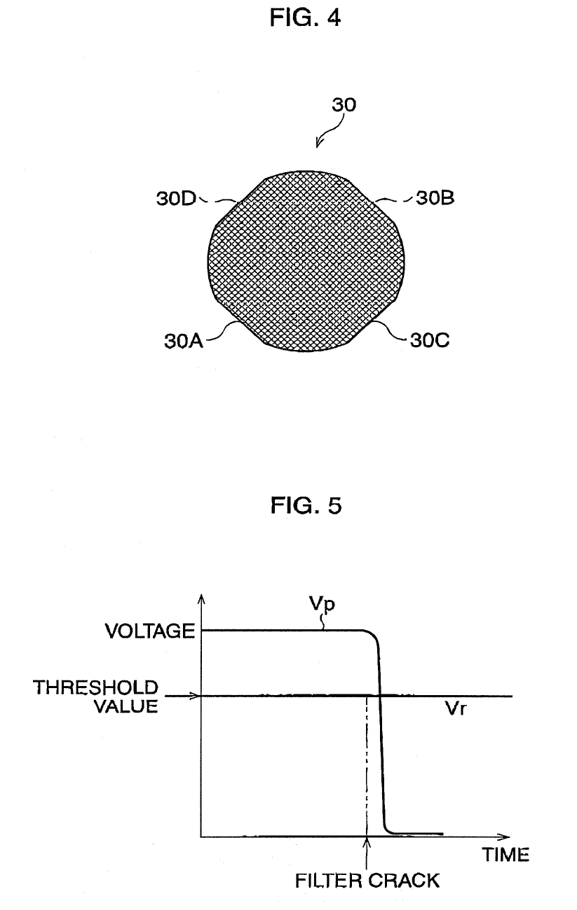

FIG. 4 is a front view showing the infrared cut filter 30. The infrared cut filter 30 is obtained by coating one or both faces of a glass substrate in which both faces are polished, with a thin layer (e.g., dielectric multilayer) which reflects or absorbs light in the infrared region and nearby wavelengths. The infrared cut filter 30 starts as an ellipse (or a circle), and is ground and polished on its lower-left, lower-right, upper-left, and upper-right sides, to form lower-left and upper-right side surfaces 30a and 30b, which are parallel, and lower-right and upper-left side surfaces 30c and 30d, which are also parallel.

The infrared cut filter 30 is disposed in such a manner that the lower-left side surface 30a and the upper-right side surface 30b are perpendicular to the diagonal D1, the lower-right side surface 30c and the upper-left side surface 30d are perpendicular to the diagonal D2, and the center of the infrared cut filter 30 is positioned at the center of the rectangular R.

With reference to FIG. 3, the laser beam output operation from the laser diode is described below. The laser beam emitted by the emitting end 50 of the laser diode 48 proceeds along the front surface 24a of the metal plate 24 to cross the optical path L of the light source (see FIG. 2). More specifically, the laser beam passes the lower-left gap 27a, and enters the lower-left side surface 30a of the infrared cut filter 30. The laser beam passes through the infrared cut filter 30, exits through the upper-right side surface 30b and passes through the upper-right gap 27b to enter the first reflecting mirror 52. That is, the path of the laser beam extends from the emitting end 50 to the first reflecting mirror 52, along the diagonal D1. Since the first diagonal D1 (i.e., the first path of the laser beam) is perpendicular to the lower-left side surface 30a and the upper-right side surface 30b, the laser beam is not refracted at these surfaces, but proceeds linearly from the emitting end 50 to the first reflecting mirror 52.

The laser beam is reflected off the first reflecting mirror 52, to proceed to the second reflecting mirror 53 along the upper side L2 of the rectangle R. The laser beam is then reflected off the second reflecting mirror 53, passes through the upper-left gap 27d, and enters the upper-left side surface 30d of the infrared cut filter 30. The laser beam passes through the infrared cut filter 30 again, exits through the lower-right side surface 30c and passes through the lower-left gap 27c to enter the light-receiving surface 51. That is, the path of the laser beam extends from the second reflecting mirror 53 to the light-receiving surface 51, along the diagonal D2, which crosses the diagonal D1. Since the second diagonal D2 (i.e., the second path of the laser beam) is perpendicular to the upper-left side surface 30d and the lower-right side surface 30c, the laser beam is not refracted at these surfaces 30d and 30c, but proceeds linearly to the light-receiving surface 51. The photodiode 49 generates a voltage in accordance with the intensity of the received light, so that the CPU 37 detects the intensity of the incident light based on the voltage.

Note that the laser beam proceeds from the first side surface to the second side surface in the infrared cut filter 30, without passing through the thin layer coated on the infrared cut filter 30. Furthermore, the path of the laser beam passing along the diagonal D1 is not necessarily perpendicular to the lower-left side surface 30a or the upper-right side surface 30b. The reason is that if the lower-left side surface 30a and the upper-right side surface 30b are parallel to each other, the laser beam exiting through the upper-right side surface 30b proceeds in the same direction as the laser beam output from the emitting end 50. Similarly, the path of the laser beam passing along the diagonal D2 is not necessarily perpendicular to the upper-left side surface 30d or the lower-right side surface 30c. Note that, in this embodiment, the laser beam exits from the infrared cut filter 30, and re-enters the infrared cut filter 30, which means that the laser beam passes through the infrared cut filter 30 twice. However, the laser beam may pass through the infrared cut filter 30 more than twice, or even just once.

FIG. 5 is a graph showing the voltage level generated in the photodiode 49. The laser beam emitted by the laser diode 48 passes through the infrared cut filter 30, and is received by the photodiode 49, as described above. In the infrared cut filter 30, the laser beam passes through the side surfaces 30a-30d, which are polished surfaces, and the glass substrate, which has high transmissibility. Therefore, the laser beam output from the laser diode 48 is not reflected very much by the infrared cut filter 30, so that a large amount of light is received by the photodiode, and thus, the value Vp of the detected voltage generated in the photodiode 40 is relatively high.

On the other hand, if a crack appears in apart of the infrared cut filter 30, the laser beam will be diffusely reflected by the crack. Therefore, most of the laser beam emitted from the laser diode will not enter the photodiode, so that the detected voltage value Vp will drop.

In this embodiment, a threshold value Vr is stored in a memory (not shown) before product shipment, for example, and the detected voltage value Vp is compared with the threshold value Vr, so that the presence of a crack in the infrared filter 30 can be detected. The threshold value Vr is lower than the detected voltage value Vp generated when the infrared cut filter 30 is intact (for example, around 70% of the detected voltage value Vp), and is sufficiently higher than the detected voltage value Vp generated when the infrared cut filter 30 is cracked. Note that, when the lamp 22 is turned on, light emitted by the lamp 22 scatters, and only a part of the light enters the photodiode 49. Therefore, the threshold value Vr is set to different values according to whether the lamp 22 is on or off.

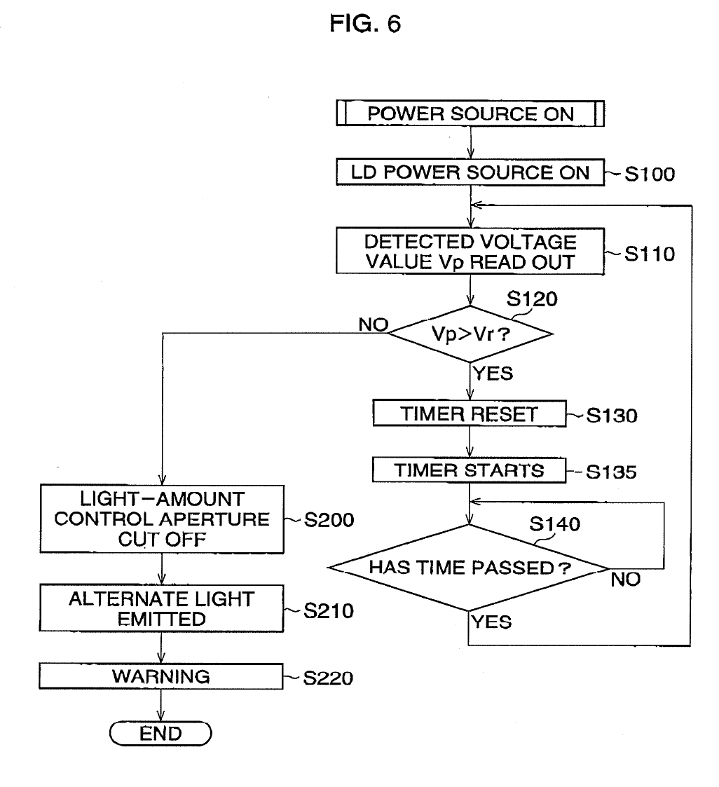

FIG. 6 is a flowchart illustrating the condition detection routine executed in the video processor 20. This routine is started when the electric power source is turned on. In Step S100, the power source of the laser diode 48 is turned on, so that a laser beam is emitted from the emitting end 50. In Step S110, the detected voltage value Vp generated in the photodiode 49 is read out and compared with the threshold value Vr in Step S120.

When the detected voltage value Vp is less than or equal to the threshold value Vr in Step S120, it is judged that a crack has been formed in the infrared cut filter 30, and the process goes to Step S200. In Step S200, a predetermined control signal is output to the light-amount control circuit 33, so that the light-amount control aperture 31 cuts off the optical path L based on the control signal, thus preventing the illumination light beam emitted by the lamp 22 from reaching the subject. Then, in Step S210, the alternate light source 29 is slidably moved and positioned in the optical path L, so that an alternate light beam is cast on the subject, which is imaged using this alternate light beam. In Step S220, a warning is displayed on the monitor 40, by which the user may recognize the abnormal condition of the infrared cut filter 30. And then, the routine ends.

Conversely, when the detected voltage value Vp is higher than the threshold value Vp, it is judged that there is no abnormal condition in the infrared cut filter 30, and the process goes to Step S130, in which a timer is reset to 0, and the timer starts counting in Step S135. Step S140 is then carried out, in which the count value of the timer is detected. Step S140 is repeated until the count value reaches a predetermined value. When it is determined in Step S140 that the count value has reached the predetermined value or the predetermined time has passed, the process goes back to Steps S110 and S120, which are again performed, so that the condition of the infrared cut filter 30 is again checked. That is, in this embodiment, the detected voltage value Vp is detected at a fixed time intervals, to detect the existence of an abnormal condition of the infrared cut filter 30.

Note that, in this routine, instead of the operations of Steps S200 and S210, it is also possible that the quantity of illumination light emitted by the lamp 22 reaching the subject be decreased by the light-amount control aperture 31, and that it continue to be cast onto the subject. The reason is that if the quantity of light is limited, even if the infrared cut filter 30 is in an abnormal condition, the possibility of damage to living body tissue or the video scope 11 by the illumination light diminishes.

As described above, according to the first embodiment, the existence of an abnormal condition (such as a crack) of the infrared filter 30 can be detected by a simple structure. Furthermore, the laser beam proceeds along the diagonals of the rectangle R such that the laser beam crosses itself with in the filter 30, and the condition of the infrared cut filter 30 can be detected over a wide area.

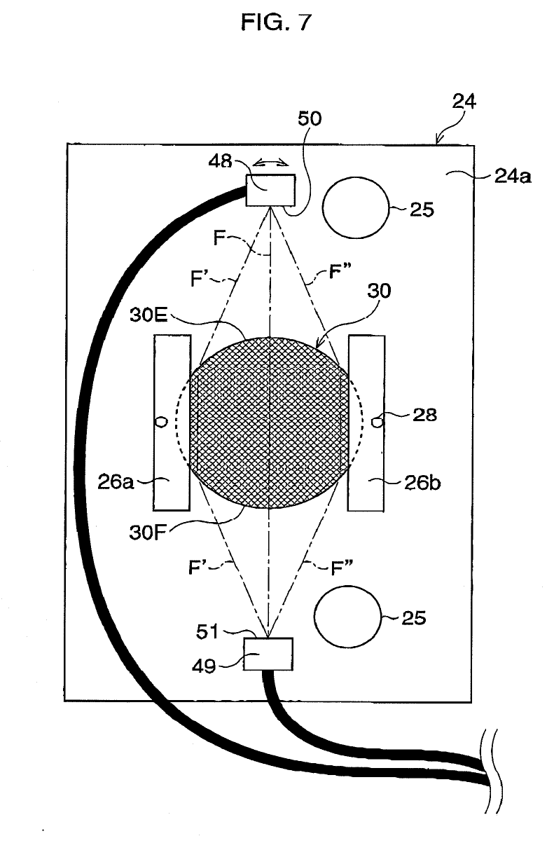

With reference to FIG. 7, a second embodiment is described below. The second embodiment has a structure similar to the first embodiment, except for members disposed on the front surface 24a of the metal plate 24. Note that in the description below, members corresponding to those of the first embodiment are given the same references, and each of the members has the same structure as in the first embodiment, with the following exception.

In the second embodiment, an infrared cut filter 30, which is circular or elliptical, is disposed at the center of the front surface 24a. The infrared cut filter 30 is fixed on the metal plate 24 with the right and left edge portions thereof sandwiched by holding portions 26a, 26b and the front surface 24a. In the infrared cut filter 30, the whole peripheral surface, or an upper surface 30e and a lower surface 30f are polished.

An emitting end 50 and a light-receiving surface 51 are attached to the front surface 24a, and disposed on the same plane as the infrared cut filter 30. The emitting end 50 and the light-receiving surface 51 are arranged above and below the infrared out filter 30, and are separated from the infrared cut filter 30, which is disposed between the emitting end 50 and the light-receiving surface 51.

The emitting end 50 faces downward so that the optical path F of the laser beam initially points in the vertical direction. From its initial position, the emitting end 50 can swing rightward and leftward. Depending on the swing direction, the emitting end 50 will face either the lower-left or lower-right, so that the optical path F of the laser beam will be inclined, and the laser beam will enter from different locations on the upper surface 30e. Note that the optical paths of the laser beam, in which the emitting end 50 is swung to the rightmost and the leftmost positions, are indicated by references F′ and F″ in FIG. 7, which extend to the leftmost end and rightmost end of the upper surface 30e.

When the emitting end 50 is at the initial position, the laser beam enters the upper surface 30e of the infrared cut filter 30 at a right angle, and exits from the lower surface 30f at a right angle, so that the laser beam proceeds straight downward, and is received by the light-receiving surface 51.

On the other hand, when the laser beam is swung rightward or leftward from the initial position, the optical path of the laser beam is inclined, so that the laser beam enters the upper surface 30e at an oblique angle. Therefore, the laser beam is refracted on the upper surface 30e, and proceeds through the infrared cut filter 30 in the vertical direction, which is parallel to the optical path F in the initial condition. The laser beam is then refracted when exiting from the lower surface 30f, so that the optical path F′ deviates from the vertical direction to strike the light-receiving surface 51.

The light-receiving surface 51 is swung rightward and leftward in accordance with the swinging movement of the emitting end 50, so that the light-receiving surface 51 can effectively receive the laser beam emitted from the lower surface 30f of the infrared cut filter 30. For example, when the emitting end 50 is at the initial position, since the optical path F of the laser beam points in the vertical direction, the light-receiving surface 51 faces upward. When the emitting end 50 is swung rightward or leftward, the light-receiving surface 51 is swung rightward or leftward so that the light-receiving surface 51 faces upper-left or upper-right, depending on the swing direction.

As described above, according to the second embodiment, the laser beam passes through the infrared cut filter 30 once to enter the light-receiving surface 51, and the optical path of the laser beam is changed by swinging the emitting end 50. Accordingly, the laser beam can cover more areas in the infrared cut filter 30 in comparison to the case in which the optical path is not changed, meaning that the condition of the infrared out filter 30 can be detected more reliably. Note that the condition detection routine of the second embodiment is the same as that of the first embodiment, except that, when the power source of the laser diode is turned on in Step S100, the swinging motions of the emitting end 50 and the light-receiving surface 51 are started. Therefore, explanation of the condition detection routine is omitted. Furthermore, in the second embodiment, the emitting end 50 and the light-receiving surface 51 can be linearly slidably moved rightward and leftward so that the optical path of the laser beam is changed.

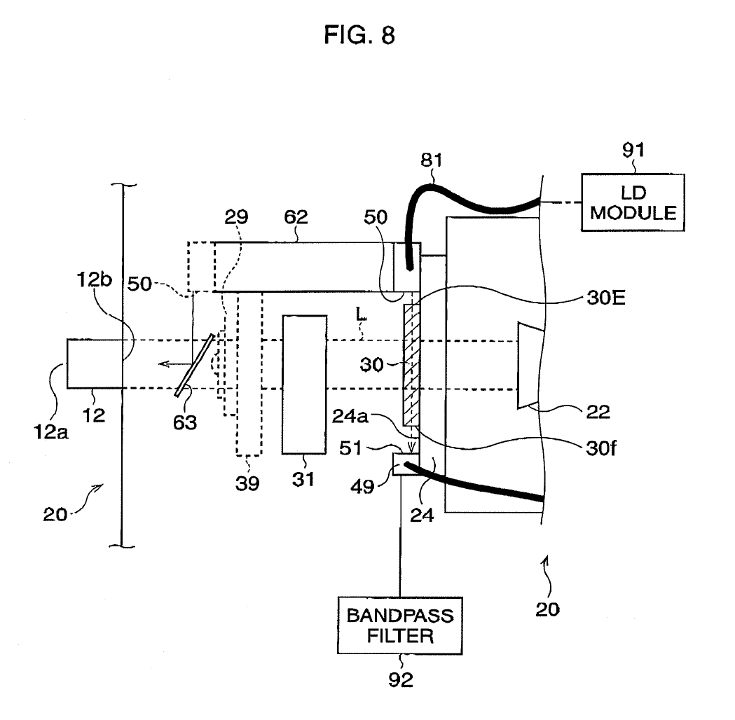

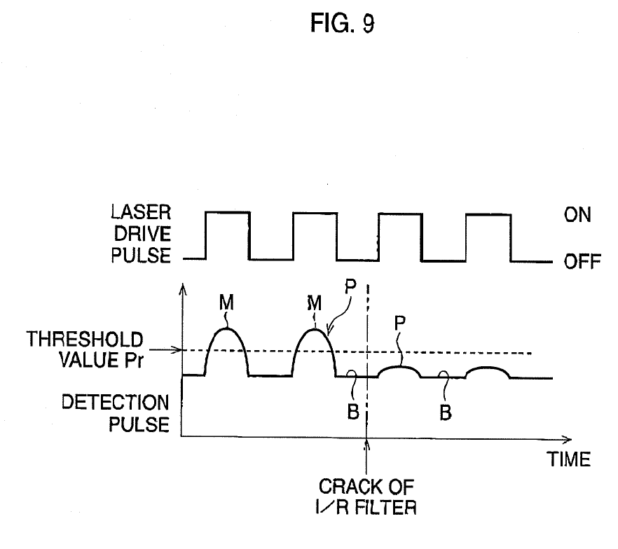

FIGS. 8 and 9 shows a third embodiment of the present invention. In the third embodiment, a second light source is provided, which emits an excitation light beam for exciting a subject. The second light source is also used as a detection light source, which detects the condition of the infrared cut filter 30. The unique elements of the third embodiment are described below.

In the third embodiment, a laser diode module (LD module) 91 is provided in the video processor 20 as a second light source. The laser beam emitted from the LD module 91 is ultraviolet radiation, which is transmitted to the emitting end 50 through an optical fiber 81, and is emitted from the emitting end 50. The emitting end 50 is supported by a slide mechanism 62 such that the emitting end 50 is slidably movable parallel to the optical path L. In the optical path L, a dichroic mirror 63 is disposed closer to the incident end 12b of the light guide 12 than the light-amount control aperture 31 and the alternate light source 29 which is positioned in the optical path L. The dichroic mirror 63 reflects light in the short wavelength region (ultraviolet radiation), and transmits the remaining light.

The infrared cut filter 30 is fixed to the front surface 24a of the metal plate 24, and either the whole peripheral surface or an upper surface 30e and a lower surface 30f are polished, similarly to the second embodiment. The light-receiving surface 51 of the photodiode 49 is disposed on the same plane as the filter 30, and is positioned below the filter 30.

As shown in FIG. 8, the emitting end 50 is located above the dichroic mirror 63, i.e., at a normal position as indicated by the broken line, in which a laser beam emitted by the emitting end 50 is reflected off the dichroic mirror 63 to proceed along the optical path L, and enter the incident end 12b of the light guide 12. The laser beam cast on the incident end 12b passes through the light guide 12, is transmitted to the emitting end 12a of the light guide 12, and is emitted toward the subject (e.g., living body tissue) through the emitting end 12a.

The emission of the laser beam is controlled by a pulse drive, in which a pulse signal is turned on and off periodically at a predetermined frequency (60 Hz, for example), so that the laser beam turns on and off repeatedly at the predetermined frequency. When, the laser beam is not emitted, light output from the lamp 22 is directed toward the subject through the light guide 12. Conversely, when the laser beam is emitted, the light output from the lamp 22 is attenuated by the light-amount control aperture 31, so that the illumination light beam of the lamp 22 and the laser beam (ultraviolet radiation) are alternately emitted toward the subject at predetermined time intervals.

The laser beam functions as an excitation light beam, and autofluorescence is generated in the living body tissue to which the laser beam is directed. The generated autofluorescence is received by the imaging device 14 (see FIG. 1), so that an autofluorescence image is formed on the imaging device 14. Therefore, when the excitation light beam is cast on a subject, an image signal corresponding to the autofluorescence image is input to the image signal processing circuit 32 (see FIG. 1). Conversely, when the illumination light beam of the lamp 22 is cast on the subject, an image signal of a normal image is input to the image signal processing circuit 32. This image signal is transmitted to the monitor 40, where the normal image and the autofluorescence image are simultaneously displayed on the monitor 40. Note that it is possible for only one of the excitation light beam or the illumination light beam to be continuously cast on the subject, such that only one of the normal image or the autofluorescence image would be displayed on the monitor 40.

When light output from the emitting end 50 is not cast on the subject, the emitting end 50 is moved from the normal position to a position above the infrared cut filter 30. This could occur, for example, when there is no intention to observe the autofluorescence image right after the electric power is turned on. In this case, the emitting end 50 is positioned in the same plane as the infrared cut filter 30. The laser beam emitted from the emitting end 50 passes through the infrared cut filter 30 from the upper surface 30e to the lower surface 30f while crossing the optical path L, and thus, the laser beam is received by the light-receiving surface 51 disposed below the infrared out filter 30.

The laser beam received by the light-receiving surface 51 is converted to a voltage signal (or detection signal) by the photodiode 49, which is connected to an electrical bandpass filter 92, which extracts signals at or near a predetermined frequency from the voltage signal, the predetermined frequency being the pulse frequency of the laser beam described above (60 Hz, for example). The extracted voltage signal is subjected to a predetermined signal process, so that the voltage signal is converted to a detection pulse P as indicated in FIG. 9. Thus, the condition of the infrared cut filter 30 is detected based on the voltage signal.

As shown in FIG. 9, due to the pulse drive, the laser beam is periodically turned on and off. When the infrared cut filter 30 is normal, since much laser light is received by the photodiode 49, each of the local maximum values M of the detection pulse P becomes drastically greater in comparison with the base value B of the detection pulse P. Conversely, when the infrared cut filter 30 has an abnormal condition such as a crack, since laser light is hardly received by the photodiode 49, the difference between each of the local maximum values M and the base value B of the detection pulse P becomes almost zero. Thus, in the third embodiment, the existence of an abnormal condition of the infrared cut filter 30 can be determined according to the difference between the local maximum value M and the base value B of the detection pulse P.

As described above, in the third embodiment, the excitation light used for observing an autofluorescence image is also used as a detection light beam for detecting the condition of the infrared cut filter 30. Therefore, the condition of the infrared cut filter 30 can be detected with a device having only a few members.

When light is emitted by the lamp 22, part of the emitted light is scattered and strikes the photodiode 49 as scattering light, so that the detection accuracy may be lowered. However, in the third embodiment, the light output by the lamp 22 which enters the photodiode 49 does not change periodically but is continuously on (i.e., low-frequency light), and much of the light is cut by the bandpass filter 92. Therefore, the condition of the infrared cut filter 30 can be detected without influence by the light of the lamp 22.

In the third embodiment, all local maximum values M of the detection pulse P may be compared with the threshold value Pr, so that the existence of an abnormal condition of the infrared cut filter 30 can be determined. As described above, since the detection pulse P is mostly unaffected by the light of the lamp 22, it is not necessary to change the threshold value Pr when turning the lamp 22 on or off.

Note that any type of bandpass filters can be used, which cut frequency components below a predetermined frequency, and transmit a component of a predetermined frequency, so that a laser beam is separated from scattered light originating from the lamp 22. For example, an optical bandpass filter may be used instead of the bandpass filter 92 in the optical path of the light entering the photodiode 49, so that light of a predetermined frequency is extracted to enter the photodiode 49.

In the first and second embodiments, it is also possible for the detection light source to emit light periodically at a predetermined frequency. Components of a predetermined frequency may then be selectively extracted by a bandpass filter, and the condition of the infrared cut filter 30 may be detected based on the extracted components.

Note that although in the first, second, and third embodiments the optical filter whose condition is detected is an infrared filter, the optical filter is not limited to a specific kind of filter, so long as light of 21 specific wavelength is cut. That is, the infrared cut filter can be replaced by an ultraviolet cut filter.

Although the embodiments of the present invention have been described herein with reference to the accompanying drawings, obviously many modifications and changes may be made by those skilled in this art without departing from the scope of the invention.

The present disclosure relates to subject matters contained in Japanese Patent Application No. 2006-349256 (filed on Dec. 26, 2006) which is expressly incorporated herein, by reference, in its entirety.

1. A device for detecting the condition of an optical filter, which is arranged in the optical path of a light source, so as to cut light of a specific wavelength from the light emitted by said light source, said device comprising:
a detection light source that outputs a detection light beam which passes through said optical filter so that said detection light beam crosses said optical path;
a photoreceptor element that receives said detection light beam which has passed through said optical filter; and
a detection processor that detects the condition of said optical filter in accordance with the intensity of said detection light beam received by said photoreceptor element.

2. A device according to claim 1, wherein said detection light beam enters from a first side surface of said optical filter and exits through a second side surface of said optical filter, and said first and second side surfaces are polished surfaces.

3. A device according to claim 1, wherein, after said detection light beam passes through said optical filter, said detection light beam again passes through said optical filter at least once, and is received by said photoreceptor element.

4. A device according to claim 3, wherein said detection light beam passes through said optical filter along a first path, and then passes through said optical filter along a second path, which crosses said first path.

5. A device according to claim 3, wherein said optical filter is disposed at the center of a rectangle, said detection light beam proceeding along one diagonal of the rectangle to pass through said optical filter, and then proceeding along another diagonal of the rectangle to pass through said optical filter again.

6. A device according to claim 3, wherein said detection light beam reflects off a reflecting mirror at least once after passing through said optical filter and then enters said optical filter again.

7. A device according to claim 1, wherein said detection light source has an emitting end and said photoreceptor element has a light-receiving portion, said emitting end and said light-receiving portion being arranged such that said optical filter is disposed between said emitting end and said light-receiving portion, said emitting end being moveable so that said detection light beam can enter different portions of said optical filter, said light-receiving portion being moved in accordance with the movement of said emitting end so that said light-receiving portion can receive said detection light beam passing through said optical filter.

8. A device according to claim 1, wherein said detection light source turns on and off repeatedly to output said detection light beam at a predetermined frequency, said photoreceptor element converting said detection light beam to a detection signal, said photoreceptor element being connected to a bandpass filter, which extracts a signal having said predetermined frequency from said detection signal, said detection processor detecting the condition of said optical filter based on the detection signal which has been converted by said photoreceptor element and extracted by said bandpass filter.

9. An illumination device comprising:
a first light source that emits an illumination light beam towards a subject along a predetermined optical path;
an optical filter that is arranged on said optical path to remove light of a specific wavelength from said illumination light beam;
a detection light source that outputs a detection light beam, which passes through said optical filter so that said detection light beam crosses said optical path;
a photoreceptor element that receives said detection light beam which has passed through said optical filter; and
a detection processor that detects the condition of said optical filter according to the intensity of said detection light beam received by said photoreceptor element.

10. A device according to claim 9, further comprising a second light source that emits an excitation light beam for exciting a subject, the optical path of said second light source being changeable so that said excitation light beam can enter said optical filter, so that said second light source can be used as said detection light source.

11. A device according to claim 9, further comprising an alternate light source that emits an alternate light beam towards a subject, in place of said first light source, when said detection processor detects an abnormal condition of said optical filter.

12. A device according to claim 9, further comprising a light-amount control aperture that is arranged on said optical path, said light-amount control aperture blocking said optical path so that said illumination light beam does not reach said subject, or so that the quantity of said illumination light beam reaching said subject is decreased when said detection processor detects an abnormal condition of said optical filter.
